(19) United States
(12) Patent Application Publication
(10) Pub. No.: US 2025/0135522 A1
(43) Pub. Date: May 1, 2025

(54) SECONDARY BATTERY CASE MANUFACTURING DEVICE

(71) Applicant: SAMSUNG SDI CO., LTD., Yongin-si (KR)

(72) Inventors: Young Jin JANG, Suwon-si (KR); Jung Hun CHOI, Suwon-si (KR)

(21) Appl. No.: 18/657,583

(22) Filed: May 7, 2024

(30) Foreign Application Priority Data
Oct. 26, 2023 (KR) 10-2023-0144718

(51) Int. Cl. B21D 24/04

(52) U.S. Cl. CPC B21D 24/04

(57) ABSTRACT

A secondary battery case manufacturing device includes a die including a first surface and a second surface that are opposite to each other, a punch hole extending through the first surface and the second surface, a punch arranged to face the first surface and configured to press a workpiece toward the punch hole in a first direction, a knockout member arranged to face the second surface and configured to press the workpiece in a second direction opposite to the first direction, and a stamp member on the knockout member and configured to imprint a pattern on the workpiece as the knockout member comes into contact with the workpiece.

### CROSS-REFERENCE TO RELATED APPLICATION

The present application claims priority to and the benefit of Korean Patent Application No. 10-2023-0144718, filed on Oct. 26, 2023 in the Korean Intellectual Property Office, the entire disclosure of which is incorporated herein by reference.

### BACKGROUND

### 1. Field

Aspects of embodiments of the present disclosure relate to a secondary battery case manufacturing device.

### 2. Description of the Related Art

In general, with the recent rapid spread of electronic devices using batteries, such as mobile phones, laptop computers, electric vehicles, and the like, the demand for secondary batteries with high energy density and high capacity is rapidly increasing. Accordingly, research and development to improve the performance of lithium secondary batteries is actively underway.

A lithium secondary battery is a battery including a positive electrode and a negative electrode containing an active material capable of intercalation and deintercalation of lithium ions, and an electrolyte, and produces electrical energy through oxidation and reduction reactions when lithium ions are intercalated/deintercalated into/from the positive electrode and the negative electrode.

A case of the secondary battery may be manufactured by molding a sheet-shaped slug into a can (e.g., a rectangular, square, or circular can) using an extrusion method and an ironing method.

The aforementioned information disclosed in this Background section is provided for enhancement of understanding of the background technology of the present disclosure, and therefore may contain information that does not constitute the related art.

### SUMMARY

According to an aspect of embodiments of the present disclosure, a secondary battery case manufacturing device capable of concurrently (e.g., simultaneously) performing a case molding process and an imprinting process is provided.

These and other aspects and features of the present disclosure will be described in or will be apparent from the following description of some embodiments of the present disclosure.

According to one or more embodiments, a secondary battery case manufacturing device includes: a die comprising a first surface and a second surface that are opposite to each other, a punch hole extending through the first surface and the second surface, a punch arranged to face the first surface and configured to press a workpiece toward the punch hole in a first direction, a knockout member arranged to face the second surface and configured to press the workpiece in a second direction opposite to the first direction, and a stamp member on the knockout member and configured to imprint a pattern on the workpiece as the knockout member comes into contact with the workpiece.

The knockout member may include a knockout body facing the second surface and configured to move along the first direction or the second direction and a knockout pad reciprocally movable with respect to the knockout body along the first direction and the second direction and configured to contact the workpiece, and the stamp member may selectively contact the workpiece according to a moving direction of the knockout pad.

The knockout pad may be inserted into the punch hole as the knockout body is moved along the second direction.

The stamp member may include a stamp hole extending through the knockout pad and arranged to face the punch hole, a stamp rod extending from the knockout body toward the stamp hole, and a stamp extending from the stamp rod and arranged inside the stamp hole, and the stamp may protrude out of the stamp hole as the knockout pad is moved relative to the knockout body in the first direction.

The stamp may extend along the second direction from an end of the stamp rod.

The stamp member may further include a support member arranged between the knockout body and the stamp rod and configured to support the stamp rod with respect to the knockout body.

The support member may be elastically deformable.

The knockout member may further include an elastic member configured to press the knockout pad in the second direction and a stopper configured to maintain the knockout pad from being separated from the knockout body.

The elastic member may include a coil spring.

The elastic member may be arranged between the knockout body and the knockout pad.

The elastic member may be arranged such that a longitudinal direction thereof is parallel to the first direction, and ends thereof may be fixed to the knockout body and the knockout pad, respectively.

The stopper may include a first stopper extending from the knockout body and a second stopper extending from the knockout pad and contacting the first stopper as the knockout pad is moved relative to the knockout body in the second direction.

The first stopper may include a first stopper body fixed to the knockout body and a first hook extending from the first stopper body along a direction intersecting the first direction and including a first contact surface, the second stopper may include a second stopper body fixed to the knockout pad and a second hook extending from the second stopper body in a direction opposite to the extension direction of the first hook and including a second contact surface facing the first hook, and the first hook and the second hook may be sequentially arranged along the first direction.

The first contact surface and the second contact surface may be arranged in parallel.

The stamp may protrude out of the stamp hole as the knockout pad is moved with respect to the knockout body from an initial position by a first distance in the first direction.

The second stopper may contact the knockout body as the knockout pad is moved with respect to the knockout body from the initial position by a second distance greater than the first distance in the first direction.

The knockout member may further include a guide member configured to guide the relative movement of the knockout pad with respect to the knockout body.

The guide member may include a guide hole extending through any one of the knockout body and the knockout pad and a guide rod extending from another one of the knockout body and the knockout pad and inserted into the guide hole.

The guide hole and the guide rod may be arranged parallel to the first direction.

In accordance with one or more embodiments of the present disclosure, a case molding process and an imprinting process can be concurrently (e.g., simultaneously) performed by a knockout member and a stamp member, thereby providing for production of secondary battery cases at high speed.

In accordance with one or more embodiments of the present disclosure, a stamp selectively protrudes from a stamp hole according to a moving direction of a knockout pad, such that damage to a workpiece and the stamp due to a collision between the workpiece and the stamp in a process of transferring the workpiece can be prevented or substantially prevented, and deterioration of imprinting performance due to damage to the stamp can be prevented or substantially prevented.

In accordance with one or more embodiments, the stamp protrudes from the stamp hole only when a pattern is imprinted on the workpiece, such that wear of the stamp due to constant exposure of the stamp can be prevented or substantially prevented, and damage to the stamp due to a collision between a punch and the stamp can be prevented or substantially prevented during a punching operation with the punch.

However, aspects and effects obtainable through the present disclosure are not limited to the above aspects and effects, and other technical aspects and effects that are not mentioned will be clearly understood by those skilled in the art from the following description of the present disclosure.

### BRIEF DESCRIPTION OF THE DRAWINGS

The drawings attached to this specification illustrate some embodiments of the present disclosure, and further describe aspects and features of the present disclosure together with the detailed description of the present disclosure. However, the present disclosure should not be construed as being limited to the drawings.

FIG. 1 is a perspective view schematically illustrating a configuration of a secondary battery case manufacturing device according to an embodiment of the present disclosure;

FIG. 2 is an exploded perspective view schematically illustrating the configuration of the secondary battery case manufacturing device according to an embodiment of the present disclosure;

FIG. 3 is an exploded perspective view illustrating the configuration of the secondary battery case manufacturing device according to an embodiment of the present disclosure from a viewpoint different from FIG. 2;

FIG. 4 is a cross-sectional view schematically illustrating the configuration of the secondary battery case manufacturing device according to an embodiment of the present disclosure;

FIG. 5 is an exploded perspective view schematically illustrating a configuration of a knockout member and a stamp member according to an embodiment of the present disclosure;

FIG. 6 is an exploded perspective view illustrating the configuration of the knockout member and the stamp member according to an embodiment of the present disclosure from a viewpoint different from FIG. 5;

FIG. 7 is a cross-sectional view schematically illustrating the configuration of the knockout member and the stamp member according to an embodiment of the present disclosure;

FIG. 8 is an enlarged view schematically illustrating a configuration of a stopper according to an embodiment of the present disclosure;

FIG. 9 is an enlarged view schematically illustrating a configuration of a stamp according to an embodiment of the present disclosure; and

FIGS. 10 to 15 are views schematically illustrating an operation process of a secondary battery case manufacturing device according to an embodiment of the present disclosure.

### DETAILED DESCRIPTION

Herein, some embodiments of the present disclosure will be described, in further detail, with reference to the accompanying drawings. The terms or words used in this specification and claims should not be construed as being limited to the usual or dictionary meaning and should be interpreted as meaning and concept consistent with the technical idea of the present disclosure based on the principle that the inventor can be his/her own lexicographer to appropriately define the concept of the term.

The embodiments described in this specification and the configurations shown in the drawings are provided as some example embodiments of the present disclosure and do not represent all of the technical ideas, aspects, and features of the present disclosure. Accordingly, it is to be understood that there may be various equivalents and modifications that may replace or modify the embodiments described herein at the time of filing this application.

It is to be understood that when an element or layer is referred to as being “on,” “connected to,” or “coupled to” another element or layer, it may be directly on, connected, or coupled to the other element or layer or one or more intervening elements or layers may also be present. When an element or layer is referred to as being “directly on,” “directly connected to,” or “directly coupled to” another element or layer, there are no intervening elements or layers present. For example, when a first element is described as being “coupled” or “connected” to a second element, the first element may be directly coupled or connected to the second element, or the first element may be indirectly coupled or connected to the second element via one or more intervening elements.

In the figures, dimensions of the various elements, layers, etc. may be exaggerated for clarity of illustration. The same reference numerals designate the same or like elements. As used herein, the term “and/or” includes any and all combinations of one or more of the associated listed items. Further, the use of “may” when describing embodiments of the present disclosure relates to “one or more embodiments of the present disclosure.” Expressions, such as “at least one of” and “any one of,” when preceding a list of elements, modify the entire list of elements and do not modify the individual elements of the list. When phrases such as “at least one of A, B, and C,” “at least one of A, B, or C,” “at least one selected from a group of A, B, and C,” or “at least one selected from among A, B, and C” are used to designate a list of elements A, B, and C, the phrase may refer to any and all suitable combinations or a subset of A, B, and C, such as A, B, C, A and B, A and C, B and C, or A and B and C. As used herein, the terms “use,” “using,” and “used” may be considered synonymous with the terms “utilize,” “utilizing,” and “utilized,” respectively. As used herein, the terms “substantially,” “about,” and similar terms are used as terms of approximation and not as terms of degree, and are intended to account for the inherent variations in measured or calculated values that would be recognized by those of ordinary skill in the art.

It is to be understood that, although the terms “first,” “second,” “third,” etc. may be used herein to describe various elements, components, regions, layers, and/or sections, these elements, components, regions, layers, and/or sections should not be limited by these terms. These terms are used to distinguish one element, component, region, layer, or section from another element, component, region, layer, or section. Thus, a first element, component, region, layer, or section discussed below could be termed a second element, component, region, layer, or section without departing from the teachings of example embodiments.

Spatially relative terms, such as “beneath,” “below,” “lower,” “above,” “upper,” and the like, may be used herein for ease of description to describe one element or feature's relationship to another element(s) or feature(s) as illustrated in the figures. It is to be understood that the spatially relative terms are intended to encompass different orientations of the device in use or operation in addition to the orientation depicted in the figures. For example, if the device in the figures is turned over, elements described as “below” or “beneath” other elements or features would then be oriented “above” or “over” the other elements or features. Thus, the term “below” may encompass both an orientation of above and below. The device may be otherwise oriented (e.g., rotated 90 degrees or at other orientations), and the spatially relative descriptors used herein should be interpreted accordingly.

The terminology used herein is for the purpose of describing embodiments of the present disclosure and is not intended to be limiting of the present disclosure. As used herein, the singular forms “a” and “an” are intended to include the plural forms as well, unless the context clearly indicates otherwise. It is to be further understood that the terms “includes,” “including,” “comprises,” and/or “comprising,” when used in this specification, specify the presence of stated features, integers, steps, operations, elements, and/or components but do not preclude the presence or addition of one or more other features, integers, steps, operations, elements, components, and/or groups thereof.

Also, any numerical range disclosed and/or recited herein is intended to include all sub-ranges of the same numerical precision subsumed within the recited range. For example, a range of “1.0 to 10.0” is intended to include all sub-ranges between (and including) the recited minimum value of 1.0 and the recited maximum value of 10.0, that is, having a minimum value equal to or greater than 1.0 and a maximum value equal to or less than 10.0, such as, for example, 2.4 to 7.6. Any maximum numerical limitation recited herein is intended to include all lower numerical limitations subsumed therein, and any minimum numerical limitation recited in this specification is intended to include all higher numerical limitations subsumed therein. Accordingly, Applicant reserves the right to amend this specification, including the claims, to expressly recite any sub-range subsumed within the ranges expressly recited herein.

References to two compared elements, features, etc. as being “the same” may mean that they are the same or substantially the same. Thus, the phrase “the same” or “substantially the same” may include a case having a deviation that is considered low in the art, for example, a deviation of 5% or less. In addition, when a certain parameter is referred to as being uniform in a given region, it may mean that it is uniform in terms of an average.

Throughout the specification, unless otherwise stated, each element may be singular or plural.

When an arbitrary element is referred to as being arranged (or located or positioned) on the “above (or below)” or “on (or under)” a component, it may mean that the arbitrary element is placed in contact with the upper (or lower) surface of the component and may also mean that another component may be interposed between the component and any arbitrary element arranged (or located or positioned) on (or under) the component.

In addition, it is to be understood that when an element is referred to as being “coupled,” “linked,” or “connected” to another element, the elements may be directly “coupled,” “linked,” or “connected” to each other, or one or more intervening elements may be present therebetween, through which the element may be “coupled,” “linked,” or “connected” to another element. In addition, when a part is referred to as being “electrically coupled” to another part, the part may be directly electrically connected to another part or one or more intervening parts may be present therebetween such that the part and the another part are indirectly electrically connected to each other.

Throughout the specification, when “A and/or B” is stated, it means A, B, or A and B, unless otherwise stated. That is, “and/or” includes any or all combinations of a plurality of items enumerated. When “C to D” is stated, it means C or more and D or less, unless otherwise specified.

The terms used in the present specification are for describing embodiments of the present disclosure and are not intended to limit the present disclosure.

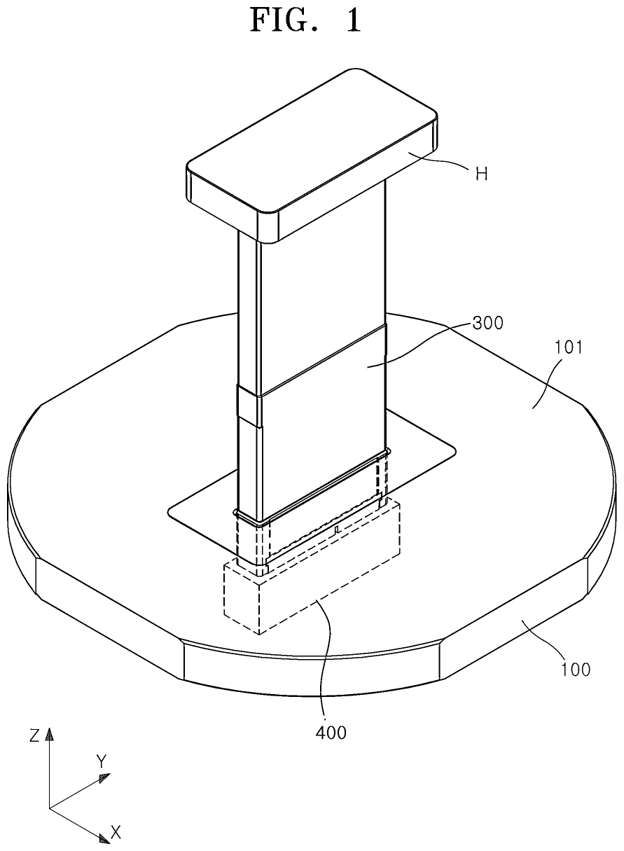

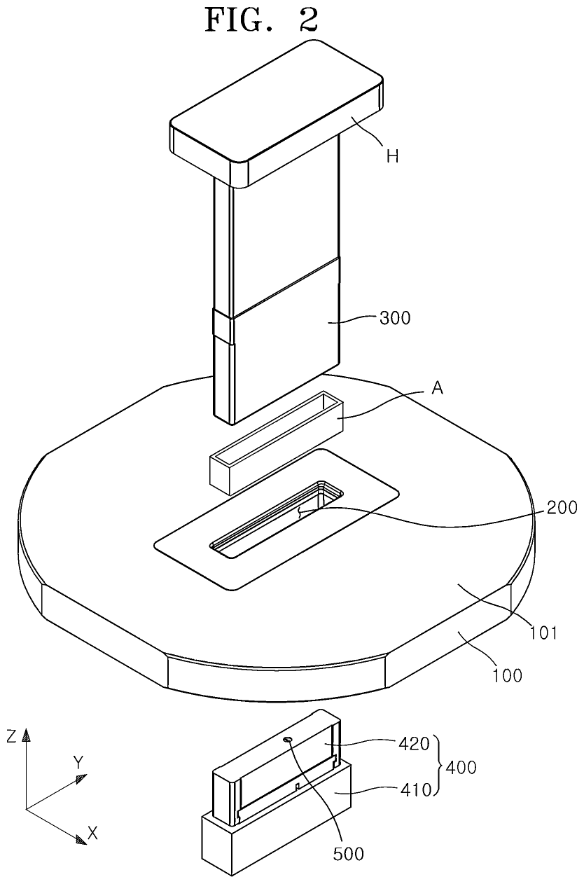

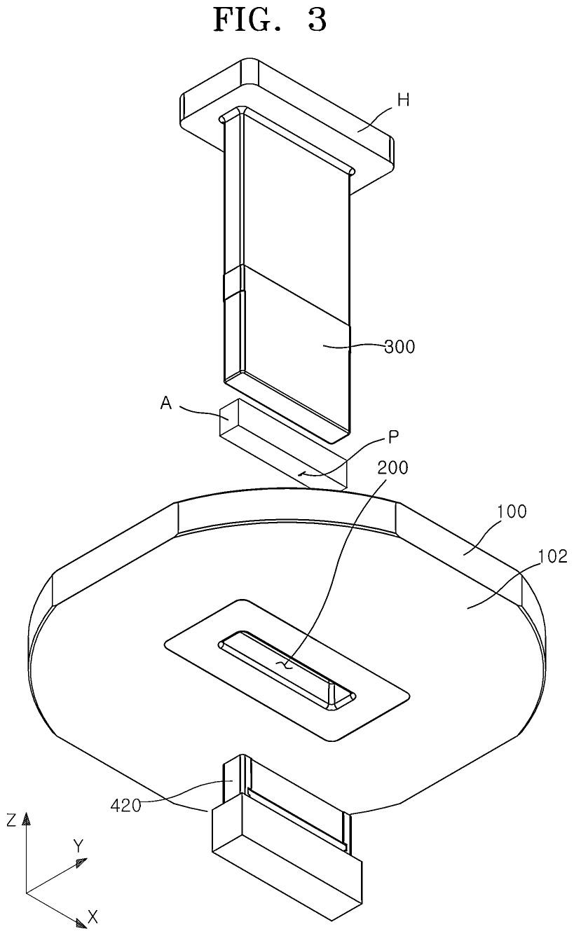

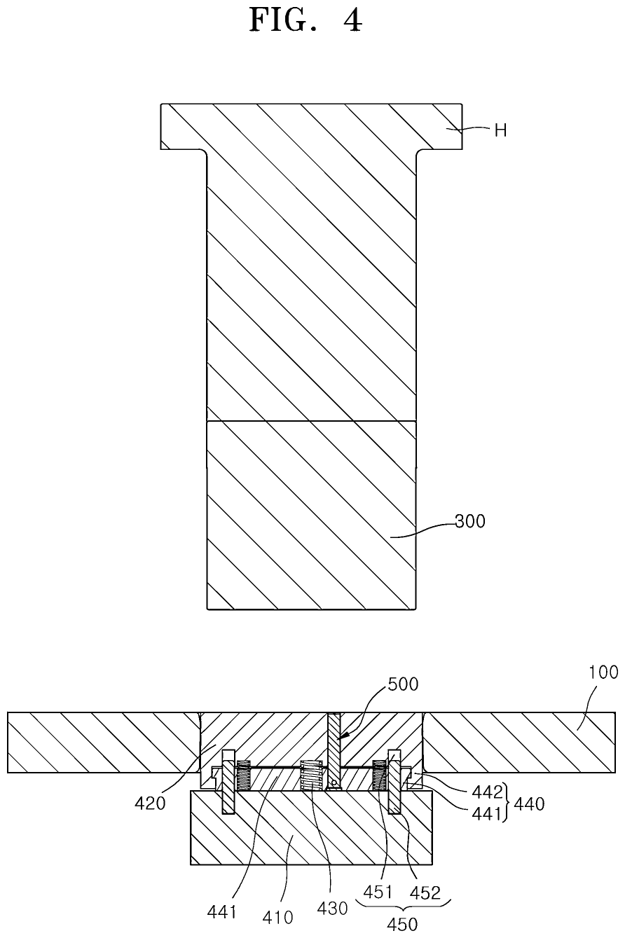

FIG. 1 is a perspective view schematically illustrating a configuration of a secondary battery case manufacturing device according to an embodiment of the present disclosure; FIG. 2 is an exploded perspective view schematically illustrating the configuration of the secondary battery case manufacturing device according to an embodiment of the present disclosure; FIG. 3 is an exploded perspective view illustrating the configuration of the secondary battery case manufacturing device according to an embodiment of the present disclosure from a viewpoint different from FIG. 2; and FIG. 4 is a cross-sectional view schematically illustrating the configuration of the secondary battery case manufacturing device according to an embodiment of the present disclosure.

Referring to FIGS. 1 to 4, a secondary battery case manufacturing device according to the present embodiment includes a die 100, a punch hole 200, a punch 300, a knockout member 400, and a stamp member 500.

The die 100 may have a shape of a plate having a first surface 101 and a second surface 102 that are opposite to each other. The die 100 may be fixed to the ground or a separate structure (not illustrated) by any of various types of coupling methods, such as welding, bolting, and insertion coupling. Herein, the first surface 101 and the second surface 102 of the die 100 will be described as being an upper surface and a lower surface of the die 100 perpendicular to a Z-axis, respectively, based on FIGS. 1 to 3, by way of example.

The punch hole 200 may be formed to have a shape of a hole formed through the first surface 101 and the second surface 102 of the die 100. The punch hole 200 may function for processing a workpiece A into a target shape by plastically deforming the workpiece A together with the punch 300, which will be described below.

Here, the workpiece A may be, for example, an object to be manufactured into a secondary battery case by the secondary battery case manufacturing device according to the present embodiment. In an embodiment, the workpiece A may be provided in a preformed cup shape through an extrusion process. In another embodiment, the workpiece A may be provided in the form of a sheet made of a metal material, such as aluminum. A target shape of the workpiece A is a shape of the secondary battery case manufactured by the secondary battery case manufacturing device according to the present embodiment, and in addition to an example of a rectangular parallelepiped, a design of a shape may be changed in various ways as long as the workpiece A has a shape of a container with an side open, such as a cylinder. The design of a shape and an area of a cross-section of the punch hole 200 may be changed in various ways, depending on the shape, area, and the like, of the cross-section of a secondary battery case formed by processing the workpiece A.

The workpiece A may be transferred on the first surface 101 of the die 100 by a separate transfer device (not illustrated). The workpiece A may be disposed in a position in which its bottom surface faces the punch hole 200 prior to an operation of the punch 300, which will be described below.

The punch 300 may be disposed to face the first surface 101 of the die 100. The punch 300 may be installed to be movable with respect to the first surface 101 of the die 100 in a first direction and a second direction. The first direction described below may refer to a direction parallel to the Z-axis and heading from the first surface 101 toward the second surface 102 based on FIGS. 1 to 3, and the second direction may refer to a direction opposite to the first direction, that is, a direction parallel to the Z-axis and heading from the second surface 102 toward the first surface 101 based on FIGS. 1 to 3.

The punch 300 may be disposed such that a longitudinal direction thereof is parallel to the first direction. The punch 300 may be disposed such that a first end of the punch 300, that is, a lower end based on FIGS. 1 to 3, faces the punch hole 200. A second end of the punch 300, that is, an upper end based on FIGS. 1 to 3, may be connected to a separate power device (not illustrated), such as a press, a cylinder, or the like, via a punch holder H. The punch 300 may be reciprocally moved in the first direction and the second direction by a driving force generated from the power device.

As the punch 300 is moved in the first direction, the punch 300 may press the workpiece A toward the punch hole 200 in the first direction. A cross-sectional area of the punch 300 may be formed to be smaller than a cross-sectional area of the punch hole 200. Accordingly, the punch 300 may be inserted into the inside of the punch hole 200 together with the workpiece A and extrude the workpiece A in the first direction or perform an ironing process for reducing a thickness of the workpiece A.

The knockout member 400 may be disposed to face the second surface 102 of the die 100. The knockout member 400 may be installed to be movable with respect to the second surface 102 in the first and second directions. After the punch 300 presses the workpiece A in the first direction, the knockout member 400 may move in the second direction and press the workpiece A in the second direction. That is, the knockout member 400 may cause the workpiece A to be separated from the punch hole 200 by applying a pressing force to the workpiece A in a direction opposite to the punch 300 after the workpiece A is formed by the punch 300.

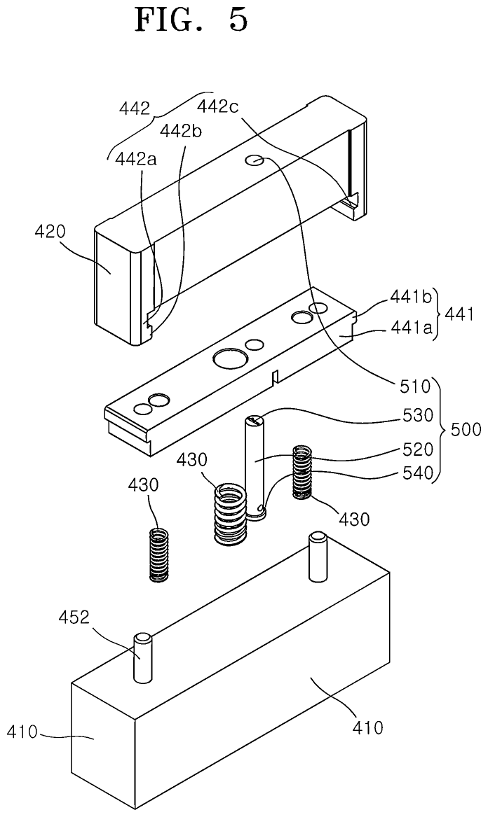

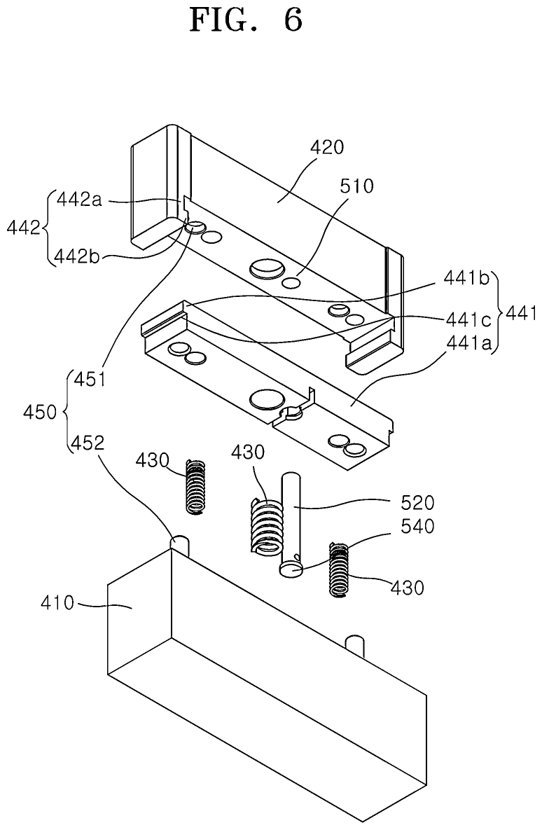

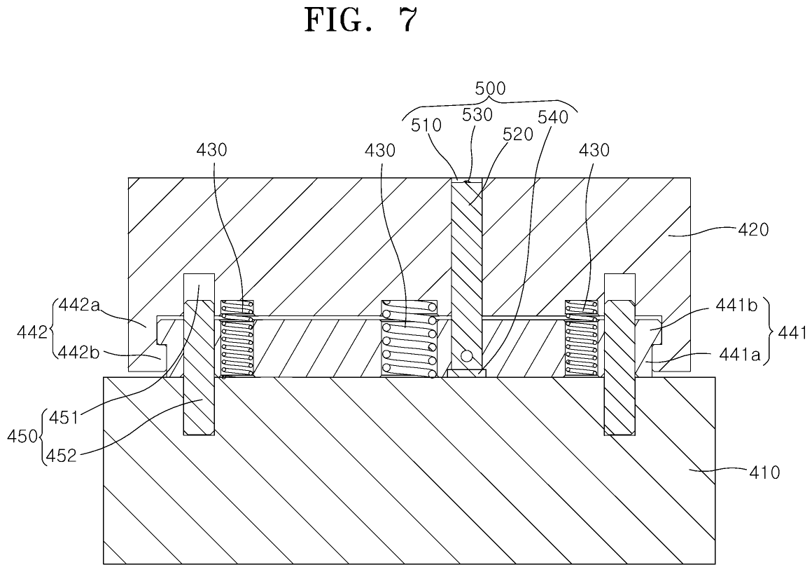

FIG. 5 is an exploded perspective view schematically illustrating a configuration of the knockout member and the stamp member according to an embodiment of the present disclosure; FIG. 6 is an exploded perspective view illustrating the configuration of the knockout member and the stamp member according to an embodiment of the present disclosure from a viewpoint different from FIG. 5; and FIG. 7 is a cross-sectional view schematically illustrating the configuration of the knockout member and the stamp member according to an embodiment of the present disclosure.

Referring to FIGS. 1 to 7, the knockout member 400 may include a knockout body 410 and a knockout pad 420.

The knockout body 410 may form an exterior of a side of the knockout member 400, and may be disposed such that a surface thereof, that is, an upper surface based on FIG. 5, faces the second surface 102 of the die 100. The knockout body 410 may be connected to a separate power device (not illustrated) such as a press or cylinder. The knockout body 410 may be reciprocally moved in the first direction and the second direction by a driving force generated from the power device.

The knockout pad 420 may be disposed to face the punch hole 200 between the knockout body 410 and the second surface 102. When the knockout body 410 is moved in the first direction and the second direction, the knockout pad 420 may be moved in the first direction and the second direction together with the knockout body 410. As the knockout body 410 is moved in the second direction, the knockout pad 420 may come into contact with a bottom surface of the workpiece A inserted into the punch hole 200 by the punch 300 and press the workpiece A in the second direction. A cross-sectional area of the knockout pad 420 may correspond to a cross-sectional area of the punch hole 200, or may be smaller than the cross-sectional area of the punch hole 200. Accordingly, when the knockout body 410 is moved in the second direction, the knockout pad 420 may be inserted into the punch hole 200 in a state of contacting the bottom surface of the workpiece A and cause the workpiece A to be separated from the punch hole 200 in the second direction.

The knockout pad 420 may be installed to be reciprocally movable with respect to the knockout body 410 along the first direction and the second direction. That is, the knockout pad 420 may be installed to be movable relative to the knockout body 410 along the first direction and the second direction, independently of the movement of the knockout body 410. In this case, the knockout pad 420 may be movably connected directly to the knockout body 410, and may also be connected to be movable relative to the knockout body 410 via a separate structure. When the knockout pad 420 comes into contact with the workpiece A, the knockout pad 420 may be moved in the first direction by a reaction force generated between the knockout pad 420 and the workpiece A. Accordingly, the knockout pad 420 may selectively expose the stamp member 500, which will be described below, to an external space.

The knockout member 400 may further include an elastic member 430, a stopper 440, and a guide member 450.

The elastic member 430 may press the knockout pad 420 with respect to the knockout body 410 in the second direction. The elastic member 430 may be provided to be elastically deformable. As an example, the elastic member 430 may have a form of a coil spring capable of expanding and contracting along a longitudinal direction.

The elastic member 430 may be disposed between the knockout body 410 and the knockout pad 420. The elastic member 430 may be disposed such that a longitudinal direction thereof is parallel to the first direction. Both ends thereof may be fixed to the knockout body 410 and the knockout pad 420, respectively. In an embodiment, both, or opposite, ends of the elastic member 430 may be fixed to surfaces where the knockout body 410 and the knockout pad 420 face each other, respectively, by an adhesive, welding, or the like. Both ends of the elastic member 430 may be inserted into surfaces where the knockout body 410 and the knockout pad 420 face each other, respectively.

When the knockout pad 420 is disposed at an initial position with respect to the knockout body 410, the elastic member 430 may be installed in a compressed state rather than a neutral state. Accordingly, the elastic member 430 may always press the knockout pad 420 with respect to the knockout body 410 in the second direction. Further details about an initial position of the knockout body 410 will be described below.

In an embodiment, a plurality of elastic members 430 may be provided. The plurality of elastic members 430 may be disposed to be spaced apart from each other between the knockout body 410 and the knockout pad 420. The plurality of elastic members 430 may be disposed parallel to each other.

The stopper 440 may prevent or substantially prevent the knockout pad 420 from being separated from the knockout body 410 by an elastic force of the elastic member 430.

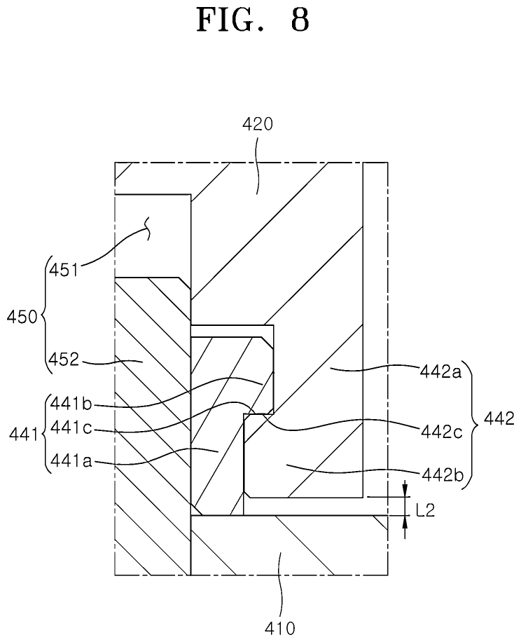

FIG. 8 is an enlarged view schematically illustrating a configuration of the stopper according to an embodiment of the present disclosure.

Referring to FIG. 8, the stopper 440 may include a first stopper 441 and a second stopper 442.

The first stopper 441 forms an exterior of a side of the stopper 440 and may extend from the knockout body 410.

The first stopper 441 may include a first stopper body 441a and a first hook 441b.

The first stopper body 441a may be disposed between the knockout body 410 and the knockout pad 420. In an embodiment, a first surface of the first stopper body 441a facing the knockout body 410 may be integrally fixed to the knockout body 410. A second surface of the first stopper body 441a facing the knockout pad 420 may come into contact with or may be separated from the knockout pad 420 by a relative movement of the knockout pad 420 with respect to the knockout body 410.

The first hook 441b may extend from the first stopper body 441a along a direction intersecting the first direction. As an example, the first hook 441b may extend from the first stopper body 441a in a direction perpendicular to the first direction, that is, along a direction parallel to a Y-axis direction based on FIG. 2. However, the extension direction of the first hook 441b is not limited thereto, and a design thereof may be changed to various directions within a range of the direction intersecting the first direction, based on FIG. 2.

A first contact surface 441c may be formed on a surface of the first hook 441b facing the knockout body 410. The first contact surface 441c may be disposed parallel to the extension direction of the first hook 441b.

In an embodiment, a plurality of first hooks 441b may be provided. The plurality of first hooks 441b may be disposed to be spaced apart from each other along a peripheral surface of the first stopper body 441a. As an example, a pair of first hooks 441b may be provided, and the pair of first hooks 441b may be disposed to be spaced apart by 180 degrees along the peripheral surface of the first stopper body 441a.

The second stopper 442 may extend from the knockout pad 420. The second stopper 442 may come into contact with the first stopper 441 as the knockout pad 420 is moved relative to the knockout body 410 in the second direction. Accordingly, movement of the knockout body 410 in the second direction due to a reaction force generated between the knockout body 410 and the first stopper 441 may be restricted.

The second stopper 442 may include a second stopper body 442a and a second hook 442b.

The second stopper body 442a may extend from a surface of the knockout pad 420 facing the knockout body 410 toward the knockout body 410. The second stopper body 442a may be disposed such that a longitudinal direction thereof is parallel to the first direction. In an embodiment, an end of the second stopper body 442a facing the knockout pad 420 may be integrally fixed to the knockout pad 420. Another surface of the second stopper body 442a facing the knockout body 410 may come into contact with or be separated from the knockout body 410 by the relative movement of the knockout pad 420 with respect to the knockout body 410. A side surface of the second stopper body 442a may be spaced apart from the peripheral surface of the first stopper body 441a along a direction intersecting the first direction. As an example, the second stopper body 442a may be spaced apart from the first stopper body 441a along a direction parallel to the extension direction of the first hook 441b.

In an embodiment, a plurality of second stopper bodies 442a may be provided. A number of the plurality of second stopper bodies 442a may be the same as the number of the first hooks 441b. Each of the second stopper bodies 442a may be individually disposed at a position facing the first hook 441b.

The second hook 442b may extend from the second stopper body 442a in a direction opposite to the extension direction of the first hook 441b. As an example, the second hook 442b may horizontally extend from an end of the second stopper body 442a facing the knockout body 410 toward a peripheral surface of the knockout body 410. The first hook 441b and the second hook 442b may be sequentially disposed along the first direction.

A second contact surface 442c may be formed on a surface of the second hook 442b facing the first hook 441b. The second contact surface 442c may be disposed parallel to the extension direction of the second hook 442b. Accordingly, the second contact surface 442c may be disposed to face the first contact surface 441c in parallel along a direction parallel to the first direction.

In an embodiment, a plurality of second hooks 442b may be provided. A number of the plurality of second hooks 442b may be the same as the number of second stopper bodies 442a. Each of the second hooks 442b may individually extend from a different second stopper body 442a.

As the elastic member 430 presses the knockout pad 420 in the second direction, when no separate external force is applied to the knockout pad 420, the first contact surface 441c and the second contact surface 442c may remain in contact with each other. The initial position of the knockout pad 420 described above may refer to the position of the knockout pad 420 in a state in which the first contact surface 441c and the second contact surface 442c are in contact.

The guide member 450 may guide the relative movement of the knockout pad 420 with respect to the knockout body 410.

The guide member 450 may include a guide hole 451 and a guide rod 452.

The guide hole 451 may be formed through any of the knockout body 410 or the knockout pad 420. Herein, the guide hole 451 will be described as being formed through the knockout pad 420 by way of example. However, the guide hole 451 is not limited thereto, and may also be formed through the knockout body 410.

The guide hole 451 may be formed to have a shape of a hole that is recessed from the surface of the knockout pad 420 facing the knockout body 410. The guide hole 451 may be disposed such that a longitudinal direction thereof is parallel to the first direction. In an embodiment, a plurality of guide holes 451 may be provided. The plurality of guide holes 451 may be disposed to be spaced apart from each other in the knockout pad 420 along the direction intersecting the first direction.

The guide rod 452 may extend from the other of the knockout body 410 and the knockout pad 420. In an embodiment, for example, the guide hole 451 is formed in the knockout pad 420, and the guide rod 452 is formed in the knockout body 410. The guide rod 452 may extend from a surface of the knockout body 410 facing the knockout pad 420 toward the knockout pad 420. The guide rod 452 may be disposed such that a longitudinal direction thereof is parallel to the first direction. The guide rod 452 and the guide hole 451 may be coaxially disposed. The guide rod 452 may be inserted into the guide hole 451. In this case, the guide rod 452 may be inserted into the guide hole 451 by passing through the first stopper body 441a. A peripheral surface of the guide rod 452 may slidably come into contact with an inner surface of the guide hole 451. In an embodiment, a plurality of guide rods 452 may be provided. Each of the guide rods 452 may be individually inserted into a respective guide hole 451.

The stamp member 500 may be installed on the knockout member 400, and as the knockout member 400 comes into contact with the workpiece A, a pattern P may be imprinted on the workpiece A. Accordingly, the stamp member 500 may imprint the pattern P on the workpiece A during the molding process of the workpiece A using the punch 300 such that production efficiency for the secondary battery case may be further improved. Here, the pattern P may be imprinted in an engraved form on the bottom surface of the workpiece A. The pattern P may have any of various shapes, such as letters, symbols, numbers, figures, and the like.

The stamp member 500 may selectively contact the workpiece A according to a direction of the relative movement of the knockout pad 420 with respect to the knockout body 410. In an embodiment, when the knockout pad 420 is moved in the first direction in a state in which the knockout pad 420 is in contact with the workpiece A, the stamp member 500 may protrude out of the knockout pad 420 and come into contact with the workpiece A. When no separate external force is applied to the knockout pad 420 or when the knockout pad 420 is moved in the second direction, the stamp member 500 may be positioned inside the knockout pad 420 and thus not be in contact with the workpiece A. Accordingly, when the knockout pad 420 is inserted into the punch hole 200, damage to the workpiece A due to interference between the stamp member 500 and the workpiece A during the transfer process of the workpiece A may be prevented or substantially prevented.

In an embodiment, the stamp member 500 may include a stamp hole 510, a stamp rod 520, and a stamp 530.

The stamp hole 510 may be formed through the knockout pad 420. Both, or opposite, ends of the stamp hole 510 may pass through both, or opposite, surfaces of the knockout pad 420 perpendicular to the first direction. The stamp hole 510 may be disposed to face the punch hole 200. The stamp hole 510 may be disposed to face a region where the pattern P is formed on the bottom surface of the workpiece A inserted into the punch hole 200. The stamp hole 510 may be disposed such that a longitudinal direction thereof is parallel to the first direction.

The stamp rod 520 may extend from the knockout body 410 toward the stamp hole 510. The stamp rod 520 may have a rod shape extending from a surface of the knockout body 410 facing the knockout pad 420 toward the knockout pad 420. The stamp rod 520 may be disposed such that a longitudinal direction thereof is parallel to the first direction. The stamp rod 520 and the stamp hole 510 may be disposed at positions where their central axes are coaxial. The stamp rod 520 may be inserted into the stamp hole 510. An outer surface of the stamp rod 520 may be spaced apart from an inner surface of the stamp hole 510, or may slidably contact an inner surface of the stamp hole 510.

The stamp 530 may extend from the stamp rod 520, and may be disposed inside the stamp hole 510. The stamp 530 may protrude along the second direction from an end surface of the stamp rod 520 disposed to face the punch hole 200. A cross-sectional shape of the stamp 530 may have a shape corresponding to a shape of the pattern P.

When the knockout pad 420 is moved relative to the knockout body 410 in the first direction in a state in which the knockout pad 420 is in contact with the workpiece A, the stamp 530 may protrude out of the stamp hole 510 and press the workpiece A in the second direction such that the pattern P is imprinted on the bottom surface of the workpiece A.

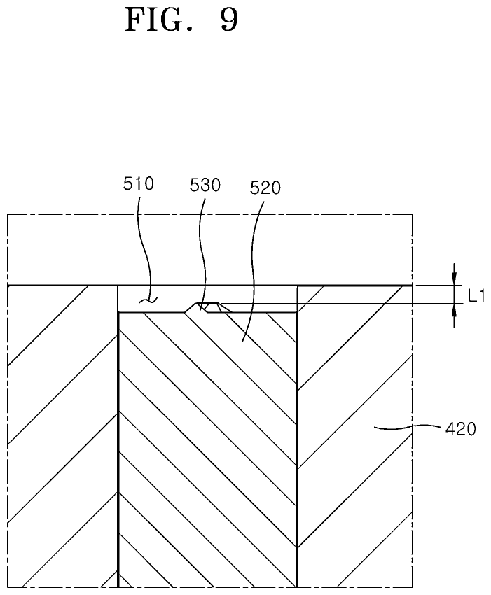

FIG. 9 is an enlarged view schematically illustrating a configuration of the stamp according to an embodiment of the present disclosure.

Referring to FIGS. 8 and 9, as the knockout pad 420 is moved relative to the knockout body 410 from an initial position by a first distance (e.g., a first set distance) L1 in the first direction, the stamp 530 may protrude out of the stamp hole 510. The first distance L1 may be changed to various values in design within a range greater than the distance between an end surface of the stamp 530 and an end surface of the stamp hole 510 facing the punch hole 200. In an embodiment, for example, the first set distance may be 0.7 mm. When the knockout pad 420 is moved relative to the knockout body 410 by the first distance L1 in the first direction in the state in which the knockout pad 420 is in contact with the workpiece A, the stamp 530 may press the workpiece A in the second direction such that the pattern P is imprinted on the bottom surface of the workpiece A.

As the knockout pad 420 is moved with respect to the knockout body 410 from the initial position by a second distance (e.g., a second set distance) L2 in the first direction, the second stopper 442, that is, the second stopper body 442a, may contact the knockout body 410. The second distance L2 may be greater than the first distance L1. As an example, the second distance L2 may be 1 mm. Accordingly, when the knockout pad 420 is moved in the first direction, the second stopper 442 may delay a point in time at which the second stopper body 442a contacts the knockout body 410 from a point in time at which the stamp 530 protrudes out of the stamp hole 510, such that the issue that the stamp 530 does not protrude out of the stamp hole 510 may be prevented or substantially prevented.

The stamp member 500 may further include a support member 540.

The support member 540 may be disposed between the knockout body 410 and the stamp rod 520. Both, or opposite, sides of the support member 540 may be connected to the knockout body 410 and the stamp rod 520, respectively, to support the stamp rod 520 with respect to the knockout body 410. The support member 540 may be provided to be elastically deformable. As an example, the support member 540 may be made of an elastically deformable material, such as urethane, silicone, or rubber. Accordingly, the support member 540 may prevent or substantially prevent damage to the stamp 530 by distributing a load applied to the stamp 530 through its own elastic deformation. An elastic deformation length of the support member 540 may be smaller than the difference between the second distance L2 and the first distance L1. As an example, the elastic deformation length of the support member 540 may be 0.2 mm.

Herein, operations of the secondary battery case manufacturing device according to an embodiment of the present disclosure will be described.

Herein, the secondary battery case manufacturing device will be described as ironing a workpiece A preformed into a cup shape in an extrusion process by way of example. However, the operations described below may be equally applied to a case of performing extrusion processing on a sheet-shaped workpiece A in the secondary battery case manufacturing device.

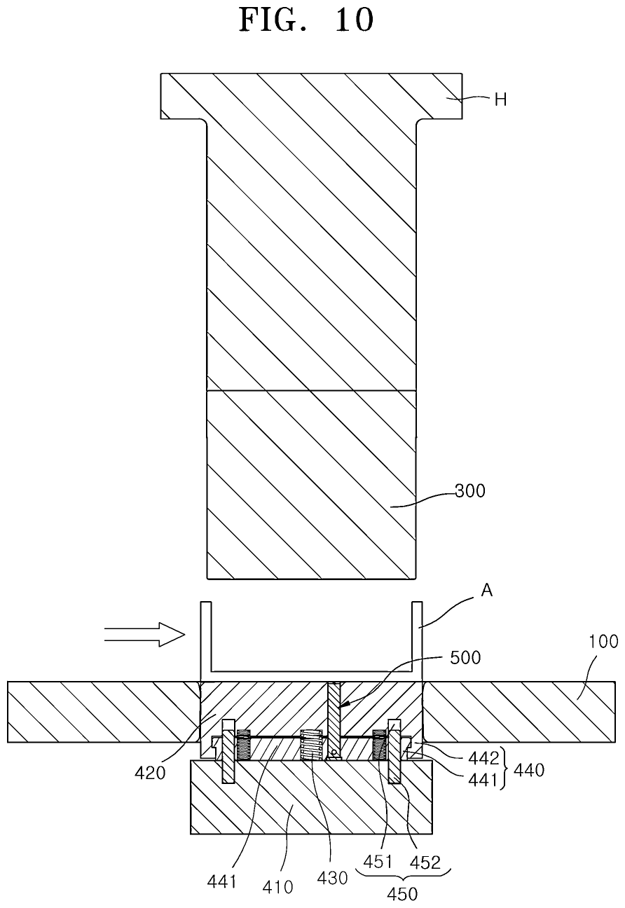

FIGS. 10 to 15 are views schematically illustrating an operation process of a secondary battery case manufacturing device according to an embodiment of the present disclosure.

Referring to FIG. 10, the punch 300 is separated from the punch hole 200, and, in a state in which the knockout pad 420 is inserted into the punch hole 200, the workpiece A is transferred to a position facing the punch hole 200.

In this case, as the knockout pad 420 is positioned at the initial position by the elastic force of the elastic member 430, the stamp 530 does not protrude out of the stamp hole 510. Accordingly, damage to the workpiece A due to a collision with the stamp 530 during the transfer process may be prevented or substantially prevented.

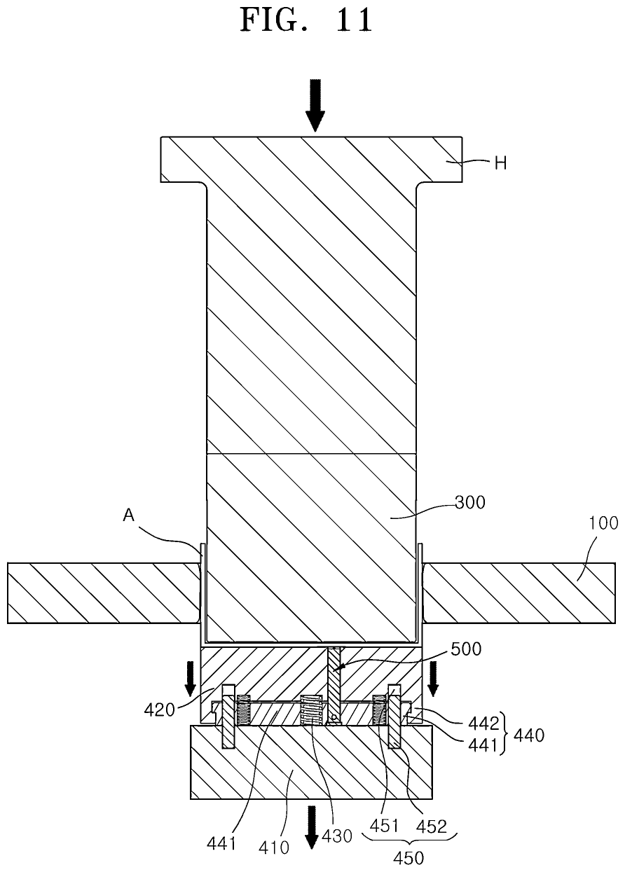

Referring to FIG. 11, the punch 300 is moved in the first direction and presses the workpiece A toward the punch hole 200 in the first direction.

The workpiece A is inserted into the punch hole 200 by a pressing force applied from the punch 300.

In this process, as the punch 300 is inserted into the inside of the punch hole 200 together with the workpiece A, the thickness of the workpiece A is reduced as much as a distance between the punch 300 and the punch hole 200.

The knockout member 400 is moved in the first direction as much as a distance moved by the punch 300 in a state in which the knockout pad 420 is in contact with the bottom surface of the workpiece A.

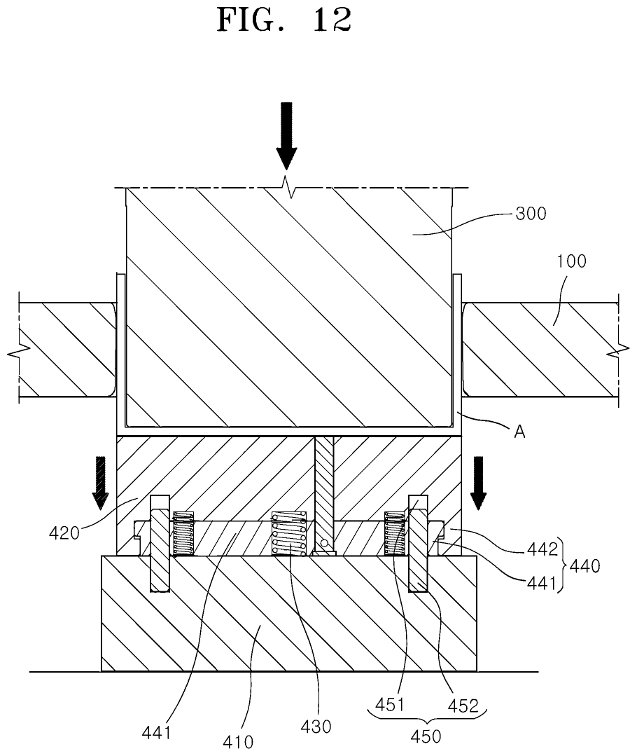

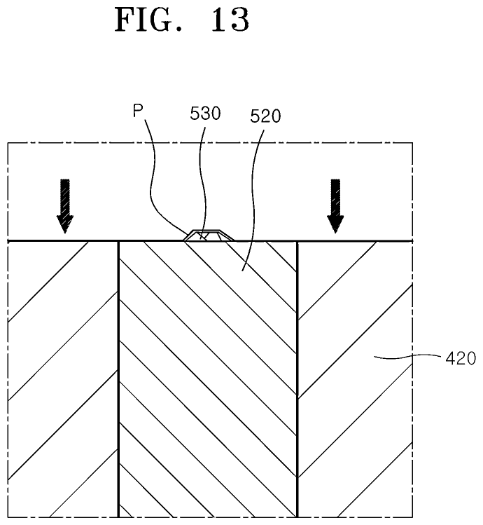

Referring to FIGS. 12 and 13, when a magnitude of the pressing force applied from the punch 300 to the workpiece A exceeds the elastic force of the elastic member 330, the knockout pad 420 is moved relative to the knockout body 410 along the first direction.

As the knockout pad 420 is moved more than the first distance L1 in the first direction, the stamp 530 protrudes out of the stamp hole 510 and presses the bottom surface of the workpiece A in the second direction.

Accordingly, the pattern P may be imprinted in the shape of the stamp 530 on the bottom surface of the workpiece A by the pressing force applied from the stamp 530.

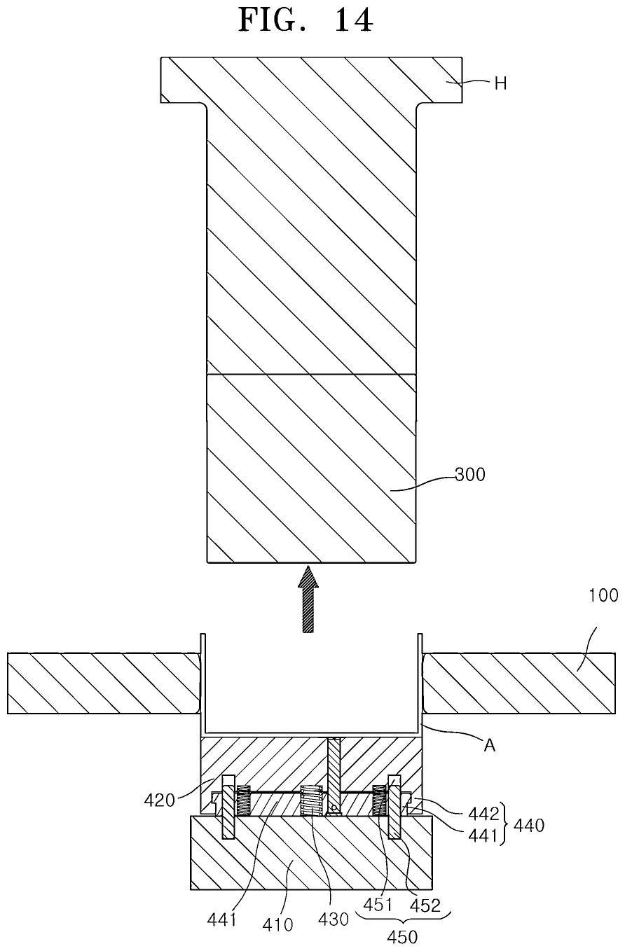

Referring to FIG. 14, after the forming of the workpiece A is completed, the punch 300 is moved along the second direction and is separated from the workpiece A.

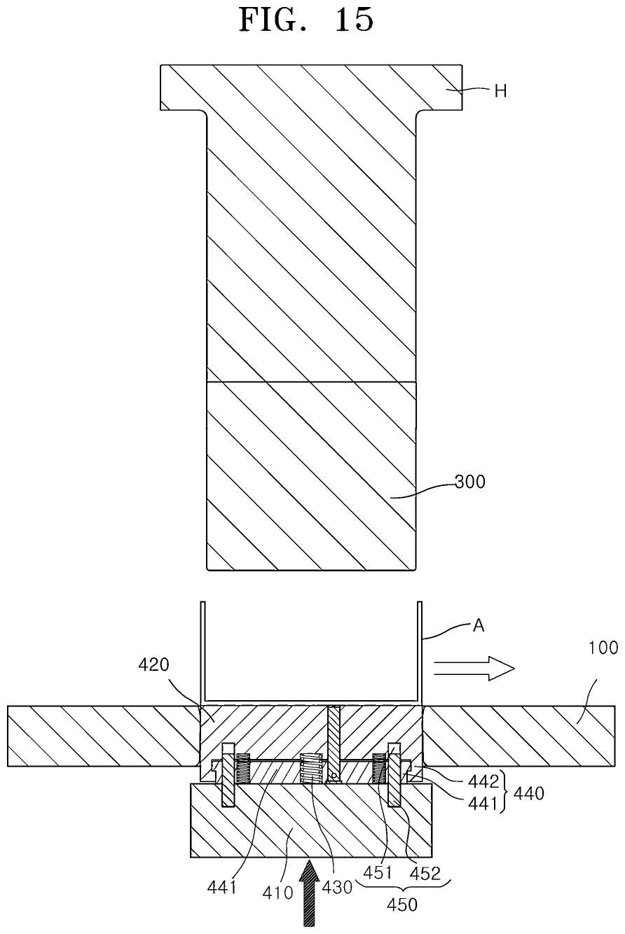

Referring to FIG. 15, after the punch 300 is separated from the workpiece A, the knockout member 400 is moved in the second direction and presses the workpiece A in the second direction.

The workpiece A is moved along the second direction by the pressing force applied from the knockout member 400 and separated from the punch hole 200.

In this process, when the magnitude of the pressing force applied by the knockout member 400 to the workpiece A exceeds an elastic force of the elastic member 330, the stamp 530 may imprint the pattern on the bottom surface of the workpiece A by performing the same operations as described in FIGS. 12 and 13.

The present disclosure has been described with regard to some example embodiments and drawings, but the present disclosure is not limited thereto, and it will be apparent to those skilled in the art that various modifications and changes may be made thereto within the technical spirit of the present disclosure and the equivalent scope of the appended claims.

What is claimed is:

1. A secondary battery case manufacturing device comprising:
a die comprising a first surface and a second surface that are opposite to each other;
a punch hole extending through the first surface and the second surface;
a punch arranged to face the first surface and configured to press a workpiece toward the punch hole in a first direction;
a knockout member arranged to face the second surface and configured to press the workpiece in a second direction opposite to the first direction; and
a stamp member on the knockout member and configured to imprint a pattern on the workpiece as the knockout member comes into contact with the workpiece.

2. The secondary battery case manufacturing device as claimed in claim 1, wherein the knockout member comprises:
a knockout body facing the second surface and configured to move along the first direction or the second direction; and
a knockout pad reciprocally movable with respect to the knockout body along the first direction and the second direction and configured to contact the workpiece, and
the stamp member is selectively contactable with the workpiece according to a moving direction of the knockout pad.

3. The secondary battery case manufacturing device as claimed in claim 2, wherein the knockout pad is insertable in the punch hole as the knockout body is moved along the second direction.

4. The secondary battery case manufacturing device as claimed in claim 2, wherein the stamp member comprises:
a stamp hole extending through the knockout pad and facing the punch hole;
a stamp rod extending from the knockout body toward the stamp hole; and
a stamp extending from the stamp rod and arranged inside the stamp hole, and
the stamp protrudes out of the stamp hole as the knockout pad is moved relative to the knockout body in the first direction.

5. The secondary battery case manufacturing device as claimed in claim 4, wherein the stamp extends along the second direction from an end of the stamp rod.

6. The secondary battery case manufacturing device as claimed in claim 4, wherein the stamp member further comprises a support member between the knockout body and the stamp rod and configured to support the stamp rod with respect to the knockout body.

7. The secondary battery case manufacturing device as claimed in claim 6, wherein the support member is elastically deformable.

8. The secondary battery case manufacturing device as claimed in claim 4, wherein the knockout member further comprises:
an elastic member configured to press the knockout pad in the second direction; and
a stopper configured to maintain the knockout pad from being separated from the knockout body.

9. The secondary battery case manufacturing device as claimed in claim 8, wherein the elastic member comprises a coil spring.

10. The secondary battery case manufacturing device as claimed in claim 8, wherein the elastic member is arranged between the knockout body and the knockout pad.

11. The secondary battery case manufacturing device as claimed in claim 10, wherein the elastic member is arranged such that a longitudinal direction thereof is parallel to the first direction, and ends thereof are fixed to the knockout body and the knockout pad, respectively.

12. The secondary battery case manufacturing device as claimed in claim 8, wherein the stopper comprises:
a first stopper extending from the knockout body; and
a second stopper extending from the knockout pad and contacting the first stopper as the knockout pad is moved relative to the knockout body in the second direction.

13. The secondary battery case manufacturing device as claimed in claim 12, wherein the first stopper comprises:
a first stopper body fixed to the knockout body; and
a first hook extending from the first stopper body along a direction intersecting the first direction and comprising a first contact surface,
the second stopper comprises:
a second stopper body fixed to the knockout pad; and
a second hook extending from the second stopper body in a direction opposite to an extension direction of the first hook and comprising a second contact surface facing the first hook, and
the first hook and the second hook are sequentially arranged along the first direction.

14. The secondary battery case manufacturing device as claimed in claim 13, wherein the first contact surface and the second contact surface are arranged in parallel.

15. The secondary battery case manufacturing device as claimed in claim 12, wherein the stamp protrudes out of the stamp hole as the knockout pad is moved with respect to the knockout body from an initial position by a first distance in the first direction.

16. The secondary battery case manufacturing device as claimed in claim 15, wherein the second stopper contacts the knockout body as the knockout pad is moved with respect to the knockout body from the initial position by a second distance greater than the first distance in the first direction.

17. The secondary battery case manufacturing device as claimed in claim 4, wherein the knockout member further comprises a guide member configured to guide relative movement of the knockout pad with respect to the knockout body.

18. The secondary battery case manufacturing device as claimed in claim 17, wherein the guide member comprises:
a guide hole extending through any one of the knockout body and the knockout pad; and
a guide rod extending from another one of the knockout body and the knockout pad and inserted in the guide hole.

19. The secondary battery case manufacturing device as claimed in claim 18, wherein the guide hole and the guide rod are arranged parallel to the first direction.
